(19) United States
(12) Patent Application Publication
(10) Pub. No.: US 2006/0033950 A1
(43) Pub. Date: Feb. 16, 2006

(54) Image forming apparatus

(76) Inventor: Mitsuo Nakamura, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/182,882

(22) Filed: Jul. 18, 2005

(30) Foreign Application Priority Data
Aug. 12, 2004 (JP) 2004-235641

(51) Int. Cl. G06F 3/12

(52) U.S. Cl. 358/1.15

(57) ABSTRACT

An image forming apparatus that has at least a facsimile communication function, includes an RSS-data creating unit that creates RSS data, that is data in RSS format, from a local communication history; and a communicating unit that transmits the RSS data created to a request source, based on a request, via a network.

### CROSS-REFERENCE TO RELATED APPLICATIONS

The present document incorporates by reference the entire contents of Japanese priority document, 2004-235641 filed in Japan on Aug. 12, 2004.

### BACKGROUND OF THE INVENTION

1. Field of the Invention

The present invention relates to an image forming apparatus such as a copy machine that has a facsimile communication function.

2. Description of the Related Art

Recently, there is an increase in providing XML data of RSS format (Rich Site Summary, RDF Site Summary, and Really Simple Syndication) for checking an update status of a Web site. An RSS document written in XML can describe a page title, an address, a heading, an abstract, and a time of update etc. of a Web site.

Moreover, there is a conventional management system in which a computer manages a copy machine that has a plurality of functions such as a facsimile communication function in which, communication history of a copy machine can be known using a computer via access to a Web site. This system is advantageous, because the computer can know about a status of the copy machine via a network by using a Web browser, and hence, a manager need not go to a location where the copy machine is installed, to check the status of the copy machine.

Japanese Patent Application Laid-open Publication No. 2001-94748 discloses a facsimile unit with improved reliability and operability, that includes a function of sending various other information automatically to a specific destination such as a manager, while sending a facsimile document.

However, in the conventional management system, to manage a plurality of copy machines, the computer needs to access each of the copy machines. For example, to manage ten copy machines, the computer has to make the access ten times.

### SUMMARY OF THE INVENTION

It is an object of the present invention to at least solve the problems in the conventional technology.

According to an aspect of the present invention, an image forming apparatus that has at least a facsimile communication function, includes an RSS-data creating unit that creates RSS data, that is data in RSS format, from a local communication history; and a communicating unit that transmits the RSS data created to a request source, based on a request, via a network.

According to another aspect of the present invention, a method of managing a plurality of image forming apparatuses that have at least a facsimile communication function, includes reading local communication history of an image forming apparatus; creating RSS data from the local communication history; and transmitting the RSS data to a request source via a network.

The other objects, features, and advantages of the present invention are specifically set forth in or will become apparent from the following detailed description of the invention when read in conjunction with the accompanying drawings.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a management system of a copy machine according to a first embodiment;

FIG. 2 is a block diagram of a structure of the copy machine according to the first embodiment;

FIG. 3 is an example of data in RSS format;

FIG. 4 is an example of a display by an RSS reader;

FIG. 5 is a flowchart of an operation according to the first embodiment;

FIG. 6 is a block diagram of a management system of a copy machine according to a second and a third embodiment;

FIG. 7 is a flowchart of an operation according to the second embodiment;

FIG. 8 is a flowchart of an operation according to the third embodiment;

FIG. 9 is a block diagram of a management system of a copy machine according to a fourth and a fifth embodiment;

FIG. 10 is a flowchart of an operation according to the fourth embodiment; and

FIG. 11 is a flowchart of an operation according to the fifth embodiment.

### DETAILED DESCRIPTION OF THE PREFERRED EMBODIMENTS

Exemplary embodiments of the present invention are described below with reference to the accompanying diagrams.

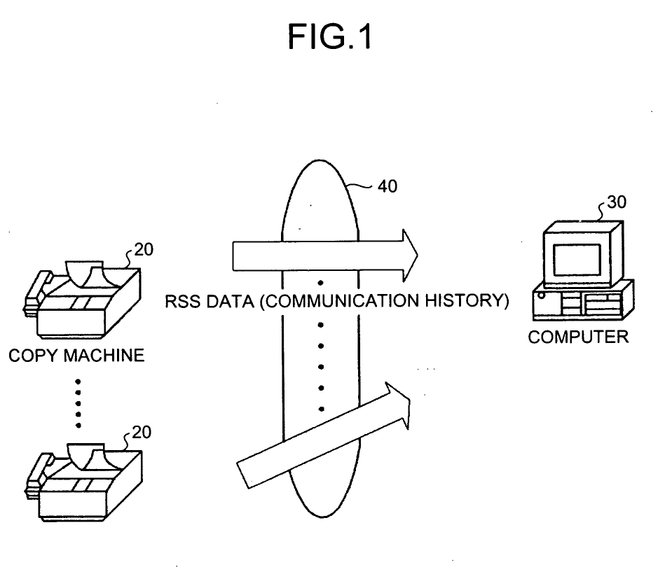

FIG. 1 is a block diagram of a management system in which a computer 30 manages a plurality of copy machines 20 via the Internet 40, according to the first embodiment related to a first and a second aspect of the present invention.

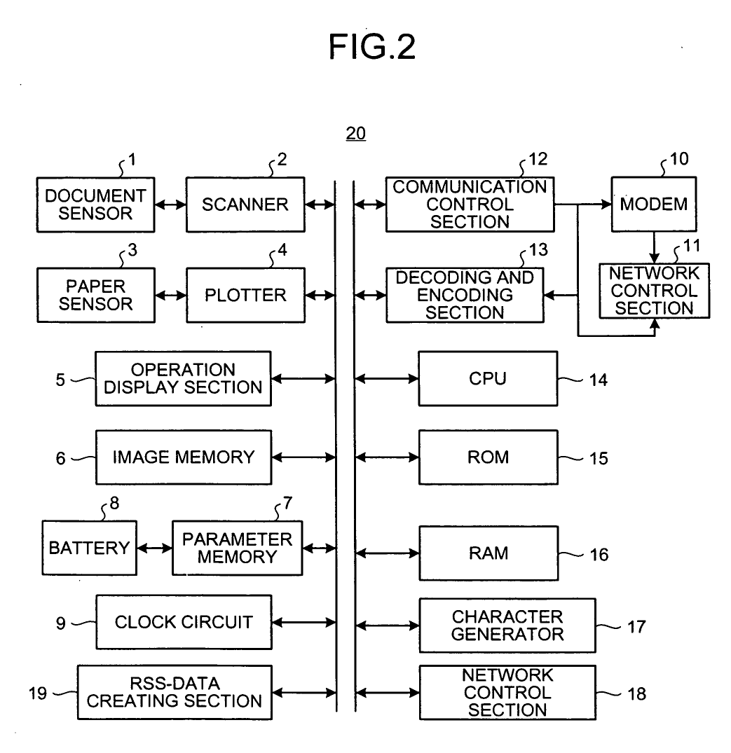

FIG. 2 is a block diagram of a structure of the copy machine 20 as an image forming apparatus that has at least a facsimile communication function according to the first embodiment of the present invention.

As shown in FIG. 2, the copy machine 20 includes an RSS-data creating section 19, and a document sensor 1 that detects whether there is a document, and checks jamming etc. of the document. A scanner 2 reads a document image, and fetches image information. A paper sensor 3 checks a position of the paper on the apparatus, and jamming of the paper. A plotter 4 records the image information, and an operation display section 5 displays a status of the apparatus and operating guidance, and is used to operate the apparatus. An image memory 6 stores image data, and a parameter memory 7 stores parameters such as a telephone number, a name of a sender/receiver etc. A battery 8 is for back up of the parameter memory 7. A clock circuit 9 is used for transmission etc.

A modem 10 modulates, demodulates, and transmits image information, as well as transmits each procedure signal in a transmission control procedure. A network control section 11 performs a predetermined call operation and receiving operation by detecting transmission and reception of a selection signal such as a telephone number of a destination of transmission and a supplement of a line. A communication control section 12 controls the modem 10 and the network control section 11, and performs facsimile communication by a predetermined transmission control procedure. A decoding and encoding section 13 encodes information to be transmitted, and decodes a document received. A CPU 14 executes a predetermined operation of the facsimile unit by controlling each section. A ROM 15 stores a program necessary for the operation of the facsimile unit. A RAM 16 stores communication history and data necessary for running the program. A character generator 17 stores character font data such as roman characters, numbers, katakana (Japanese characters), symbols, and kanji (original Chinese characters now used in Japanese). A network control section 18 controls communication with the network.

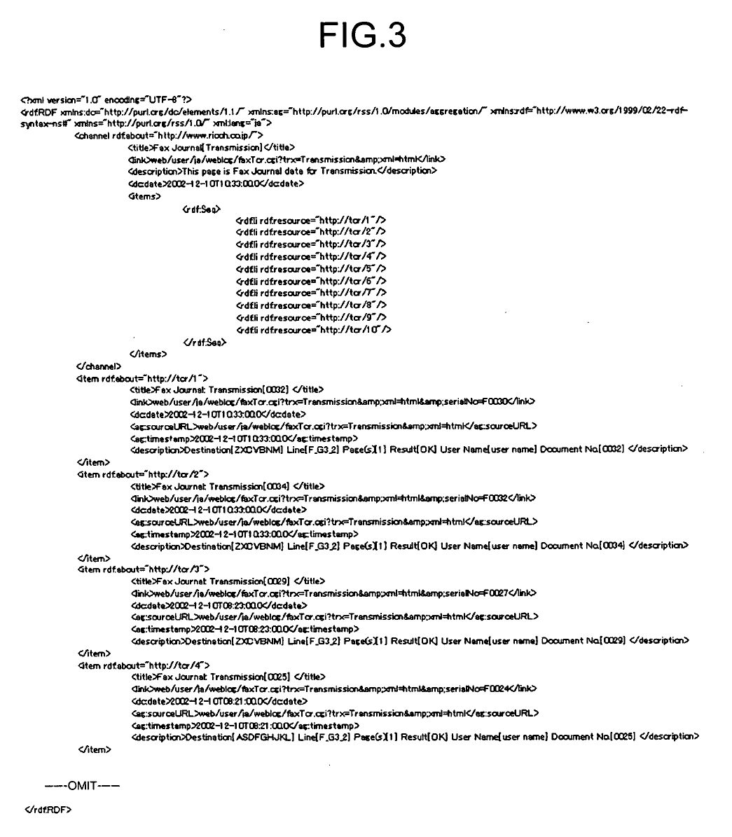

RSS is a method for checking update status of a Web site. FIG. 3 is an example of data in RSS format. This data is based on an assumption that the communication history of the facsimile is in RSS format. The RSS includes a title, a target link, and time etc.

As shown in FIG. 1, in each copy machine 20, data of the communication history stored in the RAM 16 is converted to the RSS format by the RSS-data creating section 19, and is transmitted to a client (in this case, a computer 30) via the Internet 40. Normally, a request is made by designating a URL http://xxx/, and the RSS data is transmitted by HTTP (Hyper Text Transfer Protocol). The computer 30 includes a tool such as an RSS reader, and the client views the RSS data received by using this tool. Thus, according to the first embodiment, the copy machine substantially includes a function of the Web server.

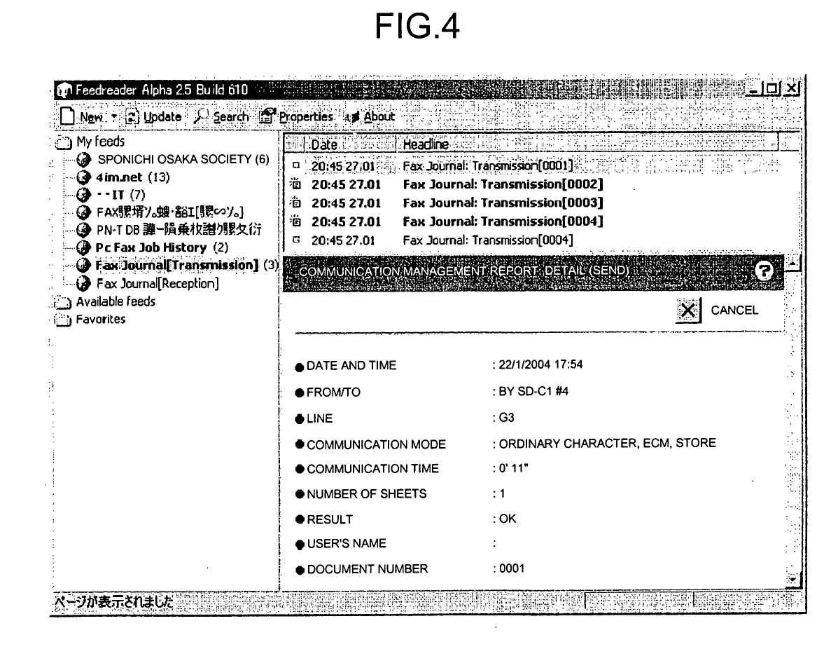

FIG. 4 is an example of a display by the RSS reader.

In FIG. 4, in a left-side column, there is a list of items with which a connection is made, and in this case, as an example, “FAX Journal . . . ” is selected. In a top-right side column, there is a list of information that is updated, and when an item is selected from this column, details of the item with which the connection is made are displayed in a column at a bottom right. This is one example, and there are various other such clients.

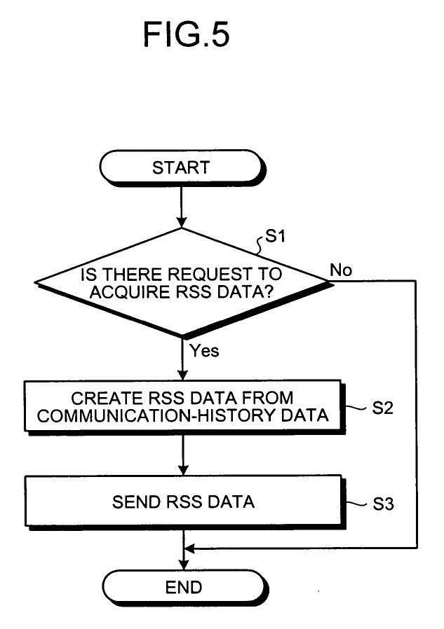

FIG. 5 is a flowchart of an operation according to the first embodiment.

In FIG. 5, when the copy machine 20 receives a request from the computer 30 using the HTTP protocol (Yes at step S1), the copy machine 20 reads communication history information from the RAM 16, and the communication history information is converted to the RSS format in the RSS-data creating section 19 (step S2). Upon conversion, the copy machine returns a response to a source of request (step S3). The RSS reader of the computer 30 performs polling of each copy machine 20 after every predetermined period of time, and displays update information.

According to the first embodiment, because a list of the update information of the plurality of copy machines 20 is displayed, one computer 30 can collectively manage the plurality of the copy machines 20. Moreover, if the information is provided in the RSS format, the purpose is served without creating a proprietary client.

According to the first embodiment, an arrangement may be made such that all or some information of management data such as “job history of the machine”, “access history of the machine” (who has logged in), “memory-use status of the machine”, and “accounting status of the machine” is transmitted to the computer 30 as data in the RSS format.

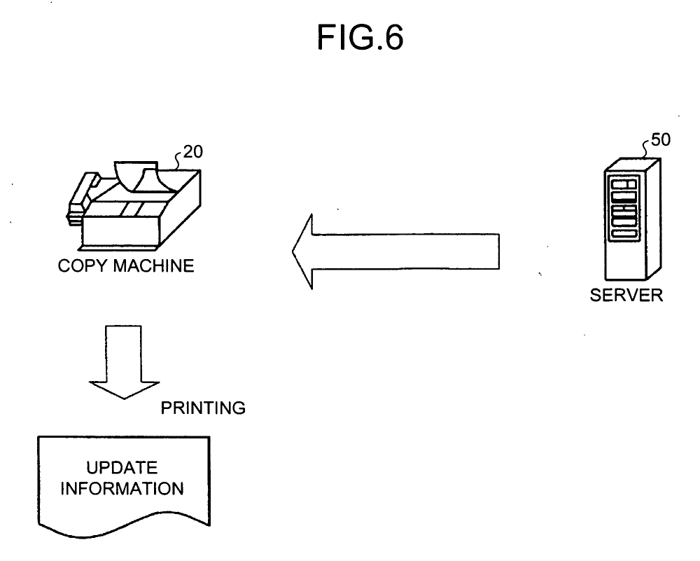

FIG. 6 is a block diagram of a second embodiment and a third embodiment that are related to a third and a fourth aspect of the present invention. Same reference numerals are used for sections that are similar to those in FIG. 1, and their description is omitted. Although only one copy machine 20 is shown in the diagram, it is assumed that there is a plurality of the copy machines 20. Moreover, the Internet 40 is not shown in the diagram.

In FIG. 6, the server 50 is a Web server that provides RSS information. The copy machines 20 include a receiving unit that receives data from the server 50, and a printing unit that prints out information on paper.

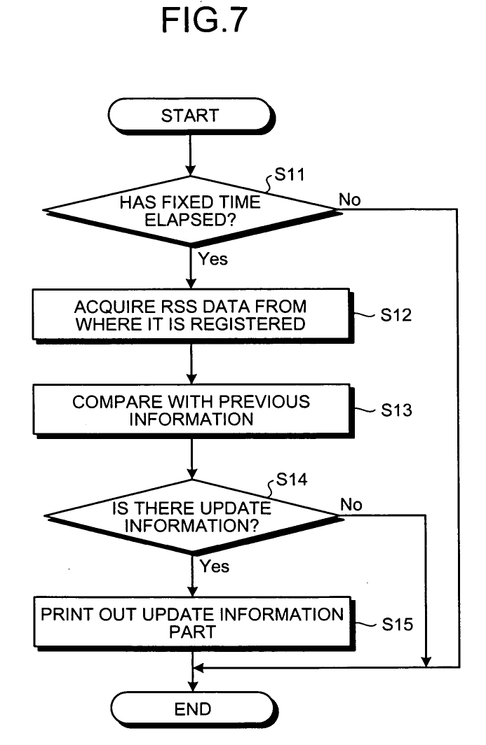

FIG. 7 is a flowchart of an operation according to the second embodiment.

In FIG. 7, after every predetermined period of time (Yes at step S11), the copy machine 20 acquires RSS data from the server 50 by assigning a registered URL (step S12). The RSS data acquired is stored in the RAM 16 or an HDD (Hard Disc Drive). Next, the RSS data is compared with an RSS data that was acquired the previous time (step S13), and if there is new update information (Yes at step S14), it is printed out on paper (step S15).

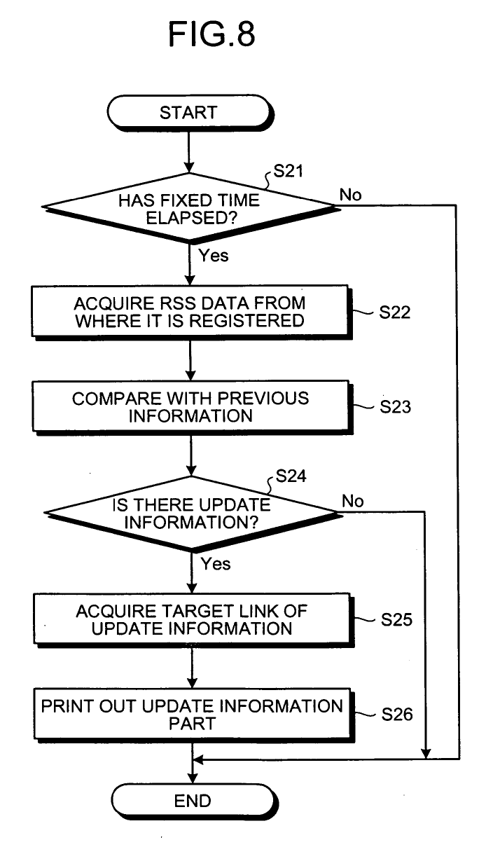

FIG. 8 is a flowchart of an operation according to the third embodiment.

In FIG. 8, after every predetermined period of time (Yes at step S21), the copy machine 20 acquires the RSS data from the server 50 by assigning a registered URL (step S22). The RSS data acquired is stored in the RAM 16 or the HDD. Next, the RSS data is compared with the RSS data that was acquired the previous time (step S23), and if there is new update information (Yes at step S24), target link of the update information is acquired (step S25), and is printed out on the paper (S26).

According to the second embodiment, all information that is managed by the server 50 is provided to the copy machine 20 in the RSS format, and the copy machine 20 is able to know the update status. Therefore, it is easy to perform remote management.

According to the third embodiment, outputting the update information automatically enables to know the type of update that occurred (left in a record).

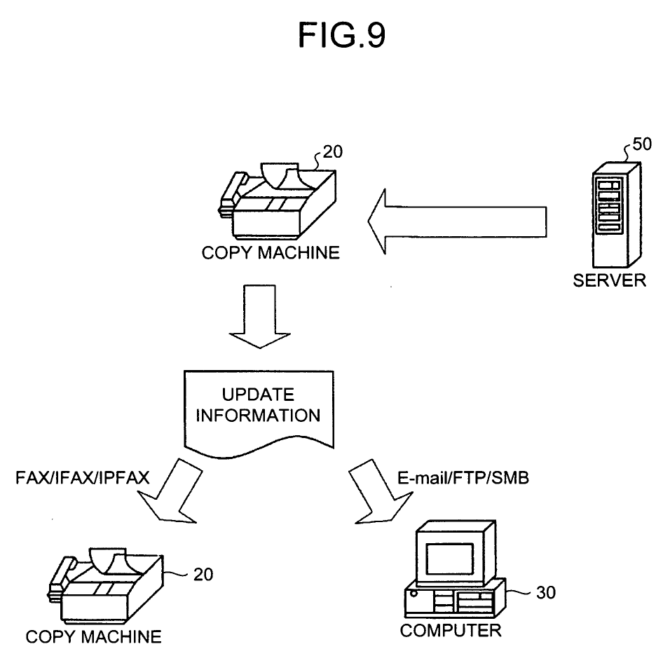

FIG. 9 is a block diagram of a fourth and a fifth embodiment related to a fifth and a sixth aspect of the present invention. Same reference numerals are used for sections that are similar to those in FIG. 6, and their description is omitted. Moreover, only one copy machine 20 is shown in the diagram, and other copy machines and the Internet are not shown in the diagram.

In FIG. 9, the update information acquired by the copy machine 20 is transmitted to the other copy machines 20 and to the computer 30.

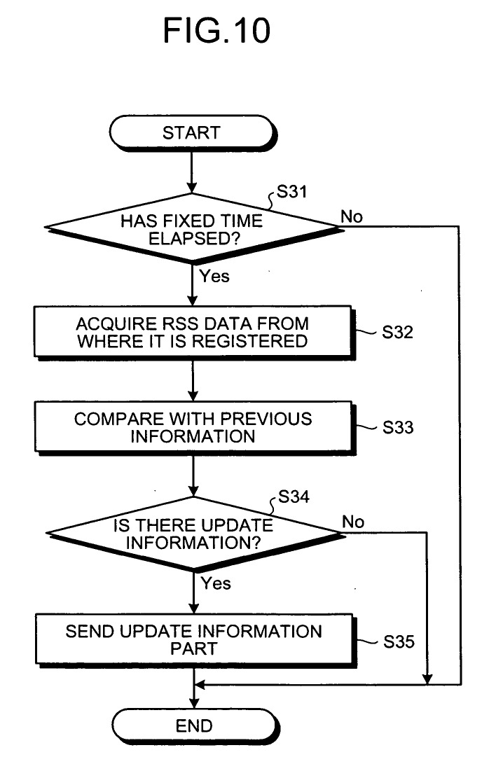

FIG. 10 is a flowchart of an operation according to the fourth embodiment.

Steps S31 to S34 of FIG. 10 are same as steps S11 to S14 explained above. If there is update information, and the copy machine 20 receives the RSS data from the Web server 50, the copy machine 20 sends the RSS data to other copy machine 20 by facsimile, of a destination that is registered in advance, and sends an e-mail to the computer 30. In a case of sending a facsimile, the information is first converted to image data (step S35). In a case of sending an e-mail, the information is sent as text as it is. The transmission method may be any of an IFAX (Internet FAX), and IPFAX (Internet Protocol FAX), an FTP (File Transfer Protocol), and an SMB (Server Message Block).

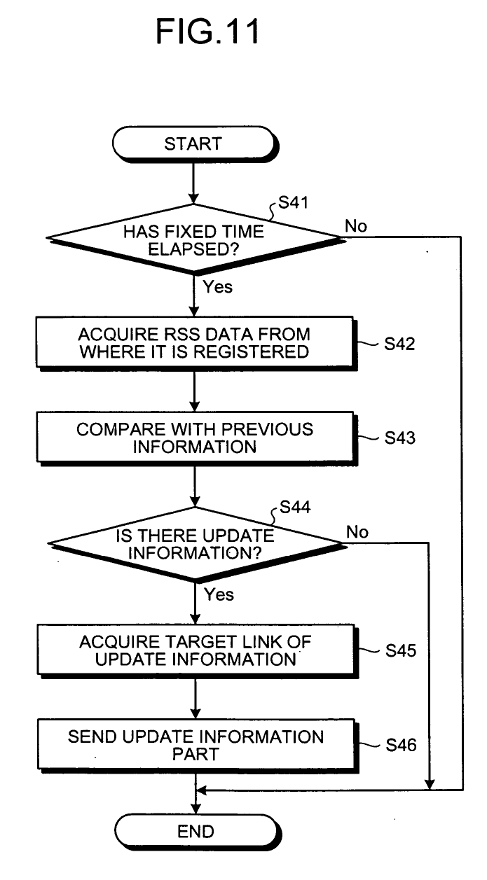

FIG. 11 is a flowchart of an operation according to the fifth embodiment of the present invention. Steps S41 to S44 are same as steps S21 to S24 explained above. If there is update information, the target link of the update information is acquired (step S45), and is transmitted to a destination that is registered in advance (step S46).

According to the fourth and the fifth embodiments, even in an environment without the computer 30 such as a personal computer, it is possible to know the update status and content of update via the facsimile function. Moreover, if the transmission is by FTP and SMB, the update information can be stored in a file.

Furthermore, the communication history is converted to the RSS data. Therefore, upon clicking on a name of the sender/receiver displayed by an RSS title, it is possible to jump to the target link indicated by the URL to get to the details of the target link. Moreover, in a case of LS documents (documents stored in HD), when a document name is clicked, it is possible to jump to the target link indicated by the URL, to read the document.

The server 50 in FIGS. 6 and 9 may be a copy machine 20 that includes the Web server function, such as the copy machine 20 in FIG. 1. In other words, the server according to aspects 3 to 6 may be the copy machine 20 that has the Web server function as shown in FIG. 1.

According to the present invention, update information can be known from a remote device. Further, plurality of machines can be managed collectively.

Moreover, various information other than communication history, of which the management is performed by a device, can also be known promptly.

Furthermore, update information (an outline) of a registered URL can be notified automatically, thus saving the user time and trouble.

Moreover, latest information can be acquired by sending automatically, a target link of the update information.

Furthermore, the update status can be known in an environment where there is no computer software (such as RSS reader).

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus that has at least a facsimile communication function, comprising:
an RSS-data creating unit that creates RSS data, that is data in RSS format, from a local communication history; and
a communicating unit that transmits the RSS data created to a request source, based on a request, via a network.

2. The image forming apparatus according to claim 1, wherein
apart from the local communication history, the RSS-data creating unit creates the RSS data from at least one of a local job history, a local access history, a local memory-usage status, and a local account status.

3. The image forming apparatus according to claim 1, further comprising:
a receiving unit that receives, from a server, the RSS data of the local communication history;
a comparing unit that compares the RSS data received with an RSS data that was received at a previous time; and
a printing unit that prints an update information that is a result of the comparison.

4. The image forming apparatus according to claim 1, further comprising:
a receiving unit that receives, from a server, the RSS data of the local communication history;
a comparing unit that compares the RSS data received with an RSS data that was received at a previous time;
an acquiring unit that acquires data of a target link related to an update information that is a result of the comparison; and
a printing unit that prints the data acquired.

5. The image forming apparatus according to claim 1, further comprising:
a receiving unit that receives, from a server, the RSS data of the local communication history;
a comparing unit that compares the RSS data received with an RSS data that was received at a previous time; and
a transmitting unit that transmits update information that is a result of the comparison, to a destination specified.

6. The image forming apparatus according to claim 1, further comprising:
a receiving unit that receives, from a server, the RSS data of the local communication history;
a comparing unit that compares the RSS data received with an RSS data that was received at a previous time;
an acquiring unit that acquires data of a target link related to an update information that is a result of the comparison; and
a transmitting unit that transmits the data acquired to a destination specified.

7. A method of managing a plurality of image forming apparatuses that have at least a facsimile communication function, comprising:
reading local communication history of an image forming apparatus;
creating RSS data from the local communication history; and
transmitting the RSS data to a request source via a network.
